(19) United States
(12) Patent Application Publication
(10) Pub. No.: US 2016/0152927 A1
(43) Pub. Date: Jun. 2, 2016

(54) DETERGENT COMPOSITION COMPRISING GLUTAMIC-N, N-DIACETATE (GLDA), WATER AND ENZYME

(71) Applicant: Conopco, Inc., d/b/a UNILEVER, Englewood Cliffs, NJ (US)

(72) Inventors: Maria Petra J van DEURZEN, Delfgauw (NL); Robert Jan MOLL, Dordrecht (NL)

(21) Appl. No.: 14/898,578

(22) PCT Filed: Jun. 16, 2014
(86) PCT No.: PCT/EP2014/062500

§ 371 Date: Dec. 15, 2015

(30) Foreign Application Priority Data
Jun. 25, 2013 (EP) 13173507.8

(51) Int. Cl. C11D 3/33; C11D 17/04; C11D 3/386

(52) U.S. Cl. CPC C11D 3/33; C11D 3/386; C11D 17/042

(57) ABSTRACT

One aspect of the invention relates to a composition containing at least 10 wt. % of GLDA, at least 10 wt. % water and one or more active enzymes; wherein the weight ratio of GLDA to water lies within the range of 5:6 to 5:1, preferably of 9:10 to 3:1; more preferably of 1:1 to 5:2. The composition of the present invention offers the advantage that the enzyme retains it activity despite the fact that the aqueous composition contains a high amount of GLDA relative to the water content of the composition, even if this GLDA was incorporated in the form of the highly alkaline tetrasodium salt The invention also provides a process of preparing such a composition.

### TECHNICAL FIELD OF THE INVENTION

The present invention relates to a composition containing at least 10 wt. % of (glutamic-N,N-diacetic acid) GLDA, at least 10 wt. % water and one or more active enzymes; wherein the weight ratio of GLDA to water lies within the range of 5:6 to 5:1.

The composition of the present invention offers the advantage that the enzyme retains it activity despite the fact that the aqueous composition contains a high amount of GLDA relative to the water content of the composition, even if this GLDA was incorporated in the form of the highly alkaline tetrasodium salt.

The composition according to the present invention may suitably be provided in the form of a liquid, a gel or a paste. Examples of detergent compositions according to the present invention include dishwashing compositions, laundry detergents and hard surface cleaning compositions.

### BACKGROUND OF THE INVENTION

Detergent formulations typically contain a number of different active components, including builders, surfactants, enzymes and bleaching agents. Liquid and gelled detergent formulations have been developed as these products offer the advantage that they are easy to dose and/or that they can easily be dispersed into aqueous cleaning liquid. However, a major challenge in the development of liquid and gelled detergent formulations lies in the fact that enzymes tend to be unstable in aqueous formulations, especially under alkaline conditions.

Calcium and magnesium ions have a negative effect on the removal of soils by detergent compositions. In order to negate these negative effects so called ‘builders’ (complexing agents) are commonly applied in detergent compositions.

Phosphorous based builders, such as phosphates, have been used for many years in a wide variety of detergent compositions. However, as part of an increasing trend towards environmentally friendly detergent compositions, alternative building agents have been developed and these alternative builders have found their way into commercial detergent products. Glutamic-N,N-diacetate (GLDA), methyl-glycine diacetate (MGDA) and citrate are examples of environmentally friendly builders that are used in commercial detergent products.

Commercially available liquid detergent formulations containing GLDA and water typically have a neutral or moderately alkaline pH. GLDA is normally incorporated in these formulations in the form of the highly alkaline tetrasodium salt. The amount of GLDA in these formulations typically is substantially lower than the water content and acid is added to ensure that the pH does not become strongly alkaline.

Highly alkaline conditions are generally avoided in aqueous detergent formulations that contain enzymes as most enzymes rapidly loose activity when exposed to alkaline conditions. This is unfortunate, as for some detergent compositions, such as machine dishwashing detergents, a highly alkaline pH is desirable as this achieves the best washing result.

Several attempts have been made to prepare alkaline enzyme-containing detergent formulations that retain enzyme activity during storage and use.

WO 2004/009752 describes an alkaline liquid detergent composition comprising: 1 to 60% by weight of a surfactant, 0.001 to 1.0% by weight of aryl boronic acid as an enzyme inhibitor, 0.1 to 20% by weight of one or more other enzyme inhibitor selected from the group consisting of formic acid, boric acid, and a salt thereof, 0.1 to 5.0% by weight of a protease, and the balance to 100% by weight being water.

WO 91/02792 describes an alkaline proteolytic enzyme that has increased protease and oxidative stability under conditions of pH 7-10 and at temperatures of 10-60° C. in aqueous solutions.

EP-A 0 348 183 describes a liquid detergent composition comprising surfactant, alkaline protease enzyme, and an enzyme-stabilising system, and characterised by the following additional features in combination:
a) a neat liquid pH of 9.5 or greater,
b) a solution pH of 8.5 or greater at 0.2% dilution in aqueous wash liquor,
c) titratable alkalinity of at least 0.5% wt. per g of product when expressed as Na₂O and titrated to pH7,
d) an effective enzyme stabiliser system selected from i) polyols, ii) boron compounds selected from boric oxide, boric acid and alkali metal borates, iii) calcium ion, iv) polyfunctional amino compounds, and mixtures thereof, and
e) 5-80% water content,
   whereby said liquid detergent composition shows at least 25% of its initial enzyme activity after storage at 40.6° C. for 2 weeks.

US 2007/0054829 describes a combination product comprising packaging and two liquid cleansers or detergents A and B separated from each other in the packaging and comprising the following composition:
A. 10% to 75% by weight of one or more detergent builders,

0.1% to 10% by weight of one or more enzymes,

24.9% to 89.9% by weight of water; and
B. 10% to 75% by weight of one or more detergent builder,

25% to 90% by weight of water,

characterized in that cleanser or detergent A has a pH value (at 20° C.) between 6 and 9, cleanser or detergent B has a pH value (at 20° C.) between 9 and 14, and neither cleanser or detergent A nor cleanser or detergent B comprises more than 2% by weight of a bleaching agent.

WO 2007/141527 describes a detergent composition comprising an amino acid based builder, enzymes that are destabilized by the builder and a stabilization system for the enzymes that comprises one or more divalent metal compounds or salts and one or more non-ionic surfactants. The example of this patent application describes detergent pouches made of PVA that contain a bleach-free liquid dishwashing formulation comprising 58.7 wt. % water, 31.0 wt. % GLDA, 5.5 wt. % citric acid, protease and amylase.

DE 10 2011 000 889 describes a machine dish wash detergent, comprising:
0.5-2 wt. % of one or more enzymes comprising proteases, lipases or amylases;
0.1-2 wt. % of borax;
0.5-3 wt. % of a phosphoric acid ester;
10-30 wt. % of a complexing agent;
10-30 wt. % of a solubilizer;
2-10 wt. % of nonionic surfactants;
10-30 wt. % of propylene glycol; and
the balance water.
   GLDA is mentioned as an example of a complexing agent. Example 2 of the German patent application describes a detergent composition containing 15 wt. % GLDA (liquid) and 32 wt. % water.

WO 2009/123322 describes an automatic dishwasher composition comprising a builder and a malic acid based water-soluble sulphonated copolymer. Example 5 of this international patent application describes a bleach-free formulation comprising 53.4 wt. % water, 30.0 wt. % GLDA, 3.6% citric acid, protease and amylase.

Non-prior published patent application PCT/EP2012/074947 describes a composition comprising 20-99.7 wt. % of a continuous phase containing GLDA, water and optionally other components; and 0.3-80 wt. % of a dispersed phase comprising at least 0.3% of bleach particles by weight of the composition, said bleach particles having a particle size of at least 10 μm, wherein the continuous phase contains at least 10 wt. % of GLDA and at least 10 wt. % water and wherein the weight ratio of GLDA to water lies within the range of 5:6 to 5:1. The examples describe detergent compositions containing GLDA, water and enzyme.

Non-prior published patent application EP13171584.9 describes a pourable thixotropic detergent composition comprising a continuous phase and at least 0.3 wt. % of suspended particles comprising water-soluble surfactant, said continuous phase containing at least 10 wt. % of an aminocarboxylate chelant and at least 10 wt. % of water and said water-soluble surfactant being selected from aryl sulfonate surfactant, alkyl sulfate surfactant and combinations thereof. The examples describe detergent compositions containing GLDA, water and enzyme.

### SUMMARY OF THE INVENTION

The present inventors have unexpectedly discovered that storage stable, enzyme-, GLDA- and water-containing, detergent compositions can be produced if the balance between water and GLDA is properly tuned.

One aspect of the invention relates a composition containing at least 10 wt. % of GLDA, at least 10 wt. % water and one or more active enzymes; wherein the weight ratio of GLDA to water lies within the range of 5:6 to 5:1.

Although the inventors do not wish to be bound by theory, it is believed that the relatively high GLDA content of the present composition results in such a strong binding of the water contained in the composition that that there is virtually no water available for the formation of a highly caustic environment that is detrimental to enzyme activity.

The present invention also provides a process of preparing the aforementioned detergent composition, said process comprising combining 100 parts by weight of a liquid mixture of GLDA and water with 10-300 parts by weight of GLDA powder to produce a liquid detergent base, said liquid mixture containing 20-50 wt. % of GLDA and 50-80 wt. % water and said GLDA powder containing at least 65 wt. % GLDA; and combining the liquid detergent base with an enzyme preparation containing active enzyme.

### DEFINITIONS

The term “glutamic-N,N-diacetate” or “GLDA” as used herein refers to glutamic-N,N-diacetic acid and salts thereof.

The term “active enzyme” as used herein refers to a large biological molecule, such as a protein, that is capable of selectively catalyzing certain (metabolic) reactions.

The term “water soluble” as used herein means a solubility in distilled water of 20° C. of at least 0.01 mol/L, preferably of at least 0.1 mol/L.

The term “particles” as used herein, unless indicated otherwise, refers to a solid material in the form of, for instance, a powder, grains, granules or tablets.

The term “bleach particles” as used herein refers to particles comprising a bleaching agent that is capable of releasing peroxygen, chlorine- or bromine under conditions typically encountered during the cleansing process, especially if the present composition is diluted 10-1000 times with water having a temperature of 5-80° C.

Whenever reference is made herein to a water content, unless indicated otherwise, said water content includes unbound (free) as well as bound water.

Whenever a parameter, such as a concentration or a ratio, is said to be less than a certain upper limit it should be understood that in the absence of a specified lower limit the lower limit for said parameter is 0.

Whenever an amount or concentration of a component is quantified herein, unless indicated otherwise, the quantified amount or quantified concentration relates to said component per se, even though it may be common practice to add such a component in the form of a solution or of a blend with one or more other ingredients.

The term “comprising” is used herein in its ordinary meaning and means including, made up of, composed of, consisting and/or consisting essentially of. In other words, the term is defined as not being exhaustive of the steps, components, ingredients, or features to which it refers.

### DETAILED DESCRIPTION OF THE INVENTION

Accordingly, one aspect of the present invention relates to a composition containing at least 10 wt. % of GLDA, at least 10 wt. % water and one or more active enzymes; wherein the weight ratio of GLDA to water lies within the range of 5:6 to 5:1, preferably of 9:10 to 3:1; more preferably of 1:1 to 5:2.

Unlike the non prior published patent applications PCT/EP2012/074947 and EP13171584.9, the present composition preferably contains less than 0.3% of bleach particles by weight of the composition, said bleach particles having a particle size of at least 10 μm. Even more preferably, the composition contains less than 0.3% bleach particles by weight of the composition. Most preferably, the composition contains less than 0.3% bleaching agent by weight of the composition.

In addition, unlike EP EP13171584.9, the composition of the present invention preferably contains less than 0.3 wt. % of suspended particles comprising water-soluble surfactant selected from aryl sulfonate surfactant, alkyl sulfate surfactant and combinations thereof

The GLDA that is contained in the present composition is a strong base. Typically, the present composition, when added to demineralised water having a temperature of 20° C. in a concentration of 1 g per 100 ml of water, yields an aqueous solution having a pH of at least 8, more preferably of at least 9, even more preferably of at least 9.5, and most preferably of at least 10. The pH of the composition after such dilution preferably does not exceed 13, more preferably it does not exceed 12 and most preferably it does not exceed 11.4.

The water activity of the composition typically does not exceed 0.7. More preferably, the water activity of the composition lies within the range of 0.1-0.6, even more preferably 0.2-0.55, most preferably of 0.3-0.5 The water activity of the composition may suitably be determined by a Novasina labmaster conditioned Aw measuring device that is set at 25° C. and measured until stable.

The present composition may suitably be provided in the form of a liquid, a gel or a paste. According to a particularly preferred embodiment, the composition is a liquid or a gel.

In accordance with a preferred embodiment, the present composition contains 5-80 wt. %, more preferably 10-60 wt. % and most preferably 15-50 wt. % of GLDA.

The water content of the present composition preferably lies in the range of 10-50 wt. %, more preferably of 15-45 wt. % and most preferably of 20-35 wt. %.

Together, GLDA and water typically constitute at least 35 wt. %, more preferably at least 40 wt. %, more preferably at least 45 wt. % and most preferably at least 50 wt. % of the present composition.

The present composition may suitably contain a substantial amount of non-dissolved detergent components, such as bleaching agent, enzyme preparations and surfactants. Typically, the amount of non-dissolved detergent components does not exceed 70 wt. %. More preferably, non-dissolved detergent components represent not more than 60 wt. %, even more preferably not more than 55 wt. % and most preferably not more than 50 wt. % of the formulation.

Together the aminocarboxylate chelant, water and non-dissolved detergent components typically constitute at least 60 wt. %, more preferably at least 70 wt. % and most preferably at least 80 wt. % of the composition.

As explained herein before, the stability of the active enzyme in the present composition is dependent on the water/GLDA balance of the product.

Advantageously, the present composition contains GLDA and water in a weight ratio of GLDA to water that lies within the range of 9:10 to 3:1; more preferably of 1:1 to 5:2; and most preferably of 5:4 to 5:3.

The one or more other component that are optionally present in the composition include, for instance polyols (e.g. glycerol), acids (e.g. citric acid), viscosifiers, surfactants, perfume, preservatives and colorant. Preferably the one or more other components represent not more than 40 wt. %, more preferably not more than 30 wt. %, even more preferably not more than 20 wt. % and most preferably not more than 10 wt. % of the composition.

Examples of detergent compositions encompassed by the present invention include dishwashing compositions, laundry detergents, rim blocks and hard surface cleaning compositions. According to a particularly preferred embodiment, the detergent composition is a dishwashing composition, especially a machine dishwashing composition.

Machine dishwash detergent compositions according to the invention may suitably be dosed at levels of 5 to 40 grams per wash, more preferably at 10 to 30 grams per wash.

The inventors have unexpectedly discovered that the stability of the present composition is further improved if the composition contains 0.1-10 wt. %, preferably 0.5-4 wt. % of dissolved acid. According to a preferred embodiment, the acid is selected from sulphuric acid, citric acid and combinations thereof. The incorporation of dissolved acid in the specified amounts enables the preparation of stable bleach-containing detergent compositions having a water activity in the range of, for instance, 0.4-0.7, especially of 0.45-0.65.

### Enzymes

Examples of enzymes suitable for use in the cleaning compositions of this invention include lipases, cellulases, peroxidases, proteases (proteolytic enzymes), amylases (amylolytic enzymes) and others which degrade, alter or facilitate the degradation or alteration of biochemical soils and stains encountered in cleansing situations so as to remove more easily the soil or stain from the object being washed to make the soil or stain more removable in a subsequent cleansing step. Both degradation and alteration can improve soil removal.

Preferably, the one or more active enzymes contained in the present composition are selected from protease, amylase, cellulase, peroxidase, mannanase, pectate lyase and lipase. Most preferably, the active enzyme is selected from protease, amylase and combinations thereof.

The composition of the present invention typically contains at least 10 mg/kg, more preferably at least 20 mg/kg, even more preferably at least 50 mg/kg and most preferably at least 100 mg/kg of active enzyme. The concentration of active enzyme preferably does not exceed 50 g/kg, more preferably it does not exceed 40 g/kg and most preferably it does not exceed 30 g/kg.

According to a particularly preferred embodiment, the composition contains at least 10 mg/kg, more preferably at least 20 mg/kg and most preferably at least 50 mg/kg of active amylase.

According to another especially preferred embodiment, the composition contains at least 100 mg/kg, more preferably at least 200 mg/kg and most preferably at least 400 mg/kg of active protease.

Enzymes may be added in liquid or in encapsulated form. Examples of encapsulated enzymes are enzyme granule types D, E and HS by Genencor and granule types, T, GT, TXT and Evity™ of Novozymes.

The proteolytic enzymes in this invention include metalloproteases and serine proteases, including neutral or alkaline microbial serine protease, such as subtilisins (EC 3.4.21.62). The proteolytic enzymes for use in the present invention can be those derived from bacteria of fungi. Chemically or genetically modified mutants (variants) are included. Preferred proteolytic enzymes are those derived from Bacillus, such as B. lentus, B. gibsonii, B. subtilis, B. licheniformis, B. alkalophilus, B. amyloliquefaciens and Bacillus pumilus, of which B. lentus and B. gibsonii are most preferred. Examples of such proteolytic enzymes are Excellase™, Properase™ Purafect™, Purafect™ Prime, Purafect™ Ox by Genencor; and those sold under the trade names Blaze™, Ovozyme™, Savinase™, Alcalase™, Everlase™, Esperase™ Relase™, Polarzyme™, Liquinase™ and Coronase™ by Novozymes.

The amylolytic enzymes for use in the present invention can be those derived from bacteria or fungi. Chemically or genetically modified mutants (variants) are included. Preferred amylolytic enzyme is an alpha-amylase derived from a strain of Bacillus, such as B. subtilis, B. licheniformis, B. amyloliquefaciens or B. stearothermophilus. Examples of such amylolytic enzymes are produced and distributed under the trade name of Stainzyme™, Stainzyme™ Plus, Termamyl™, Natalase™ and Duramyl™ by Novozymes; as well as Powerase™, Purastar™, Purastar™ Oxam by Genencor. Stainzyme™, Stainzyme™ Plus and Powerase™ are the preferred amylases.

In accordance with a particularly preferred embodiment of the invention, the composition contains active protease and the protease activity of the freshly prepared composition decreases by not more than 70%, more preferably by not more than 50% and most preferably by not more than 20% when the composition is stored in a closed container for 8 weeks at 20° C.

Well known enzyme stabilizers such as polyalcohols/borax, calcium, formate or protease inhibitors like 4-formylphenyl boronic acid may also be present in the composition.

### Bleach

The present detergent composition suitably contains a bleaching agent. It is believed that the GLDA in the present composition binds the water contained therein so strongly that it can no longer exert a destabilising effect on the bleach particles.

The bleaching agent may suitably comprise a chlorine-, or bromine-releasing agent or a peroxygen compound. Preferably, the bleaching agent is selected from peroxides (including peroxide salts such as sodium percarbonate), organic peracids, salts of organic peracids and combinations thereof. More preferably, the bleaching agent is a peroxide. Most preferably, the bleaching agent is a percarbonate.

Examples of peroxides are acids and corresponding salts of monopersulphate, perborate monohydrate, perborate tetrahydrate, and percarbonate.

Organic peracids useful herein include alkyl peroxy acids and aryl peroxyacids such as peroxybenzoic acid and ring substituted peroxybenzoic acids (e.g. peroxy-alpha-naphthoic acid), aliphatic and substituted aliphatic monoperoxy acids (e.g. peroxylauric acid and peroxystearic acid), and phthaloyl amido peroxy caproic acid (PAP).

Typical diperoxy acids useful herein include alkyl diperoxy acids and aryldiperoxy acids, such as 1,12 di-peroxy-dodecanedioic acid (DPDA), 1,9 diperoxyazelaic acid, diperoxybrassylic acid, diperoxysebacic acid and diperoxy-isophthalic acid, and 2 decyldiperoxybutane 1,4 dioic acid.

The detergent composition may contain one or more bleach activators such as peroxyacid bleach precursors. Peroxyacid bleach precursors are well known in the art. As non-limiting examples can be named N,N,N′,N′-tetraacetyl ethylene diamine (TAED), sodium nonanoyloxybenzene sulphonate (SNOBS), sodium benzoyloxybenzene sulphonate (SBOBS) and the cationic peroxyacid precursor (SPCC) as described in U.S. Pat. No. 4,751,015.

If desirable, a bleach catalyst, such as the manganese complex, e.g. Mn-Me TACN, as described in EP-A-0458397, or the sulphonimines of U.S. Pat. No. 5,041,232 and U.S. Pat. No. 5,047,163, can be incorporated. This bleach catalyst may suitably be present in the composition in the form of a encapsulate, notably an encapsulate that is separate from the bleach particles (to avoid premature bleach activation). Cobalt or iron catalysts can also be used.

### Surfactants

The present detergent composition preferably contains one or more surfactants. Surfactants, within the invention, are components within the classification as described in “Surfactant Science Series”, Vol. 82, Handbook of detergents, part A: Properties, chapter 2 (Surfactants, classification), G. Broze (ed.).

According to a particularly preferred embodiment, the composition contains 0.1-15 wt. %, more preferably 0.5-10 wt. % and most preferably 1-5 wt. % of a nonionic surfactant or a mixture of two or more non-ionic surfactants.

Examples of nonionic surfactants that may be employed in the present composition include the condensation products of hydrophobic alkyl, alkenyl, or alkyl aromatic compounds bearing functional groups having free reactive hydrogen available for condensation with hydrophilic alkylene oxide, such as ethylene oxide, propylene oxide, butylene oxide, polyethylene oxide or polyethylene glycol to form nonionic surfactants. Examples of such functional groups include hydroxy, carboxy, mercapto, amino or amido groups.

Examples of useful hydrophobes of commercial nonionic surfactants include C8-C18 alkyl fatty alcohols, C₈-C₁₄ alkyl phenols, C₈-C₁₈ alkyl fatty acids, C₈-C₁₈ alkyl mercaptans, C₈-C₁₈ alkyl fatty amines, C₈-C₁₈ alkyl amides and C₈-C₁₈ alkyl fatty alkanolamides. Accordingly, suitable ethoxylated fatty alcohols may be chosen from ethoxylated cetyl alcohol, ethoxylated ketostearyl alcohol, ethoxylated isotridecyl alcohol, ethoxylated lauric alcohol, ethoxylated oleyl alcohol and mixtures thereof.

Examples of suitable nonionic surfactants for use in the invention are found in the low- to non-foaming ethoxylated/propoxylated straight-chain alcohols of the Plurafac™ LF series, supplied by the BASF and the Synperonic™ NCA series supplied by Croda. Also of interest are the end-capped ethoxylated alcohols available as the SLF 18 series from BASF and the alkylpolyethylene glycol ethers made from a linear, saturated C₁₆-C₁₈ fatty alcohol of the Lutensol™ AT series, supplied by BASF. Other suitable nonionics to apply in the composition of the invention are modified fatty alcohol polyglycolethers available as Dehypon™ 3697 GRA or Dehypon™ Wet from BASF/Cognis. Also suitable for use herein are nonionics from the Lutensol™ TO series of BASF, which are alkylpolyethylene glycol ethers made from a saturated iso-C₁₃ alcohol.

Amineoxide surfactants may also be used in the present invention as anti-redeposition surfactant. Examples of suitable amineoxide surfactants are C₁₀-C₁₈ alkyl dimethylamine oxide and C₁₀-C₁₈ acylamido alkyl dimethylamine oxide.

The inventors have found that, a detergent composition that is not only chemically but also physically very stable can be produced if the nonionic surfactant employed is solid at ambient temperature. Thus, advantageously, the present composition contains 0.1-15 wt. %, more preferably 0.5-10 wt. % and most preferably 1-5 wt. % of nonionic surfactant that is solid at 25° C.

If an anionic surfactant is used, the total amount present preferably is less than 5 wt. %, and more preferably not more than 2 wt. %. Furthermore, if an anionic surfactant is present, it is preferred that an antifoam agent to suppress foaming is present. Examples of suitable anionic surfactants are methylester sulphonates or sodium lauryl sulphate.

### Builders

The GLDA contained in the present composition preferably is an alkali metal salt of glutamic-N,N-diacetic acid. More preferably, the GLDA employed is a sodium salt of glutamic-N,N-diacetic acid. Most preferably, the GLDA employed is a tetra sodium salt of glutamic-N,N-diacetic acid.

Compositions according to the present invention may, next to GLDA, also contain additional water-softening builders. Traditionally phosphorous based builders, such as phosphates have been used as builders, but due to environmental pressures other builders are preferred. These include organic builders such as citrate, MGDA (methyl-glycine diacetate) and inorganic builders such as carbonates, in particular sodium carbonate.

### Silicates

Silicates may be added to the formulation. Silicates can act as builder, buffering agent or article care agent. Preferred silicates are sodium silicate such as sodium disillicate, sodium metasilicate and crystalline phyllosilicates and mixtures thereof. Silicates are preferably used in the detergent composition in a concentration of 1 to 20%, more preferably of 2 to 10% by weight of the composition.

### Dispersing Polymers

In a preferred embodiment of the current invention, the detergent composition furthermore comprises at least one dispersing polymer. Dispersing polymers as referred to in this invention are chosen from the group of anti-spotting agents and/or anti-scaling agents.

Examples of suitable anti-spotting polymeric agents include hydrophobically modified polycarboxylic acids such as Acusol™ 460 ND (ex Dow) and Alcosperse™ 747 by AkzoNobel, whereas also synthetic clays, and preferably those synthetic clays which have a high surface area are very useful to prevent spots, in particular those formed where soil and dispersed remnants are present at places where the water collects on the glass and spots formed when the water subsequently evaporates.

Examples of suitable anti-scaling agents include organic phosphonates, amino carboxylates, polyfunctionally-substituted compounds, and mixtures thereof. Particularly preferred anti-scaling agents are organic phosphonates such as [symbol] -hydroxy-2 phenyl ethyl diphosphonate, ethylene diphosphonate, hydroxy 1,1-hexylidene, vinylidene 1,1-diphosphonate, 1,2-dihydroxyethane 1,1-diphosphonate and hydroxy-ethylene 1,1-diphosphonate. Most preferred is hydroxy-ethylene 1,1-diphosphonate (EDHP) and 2-phosphono-butane, 1,2,4-tricarboxylic acid (Bayhibit ex Bayer).

Suitable anti-scaling agents are water soluble dispersing polymers prepared from an allyloxybenzenesulfonic acid monomer, a methallyl sulfonic acid monomer, a copolymerizable nonionic monomer and a copolymerizable olefinically unsaturated carboxylic acid monomer as described in U.S. Pat. No. 5,547,612 or known as acrylic sulphonated polymers as described in EP 851 022. Polymers of this type include polyacrylate with methyl methacrylate, sodium methallyl sulphonate and sulphophenol methallyl ether such as Alcosperse™ 240 supplied (AkzoNobel). Also suitable is a terpolymer containing polyacrylate with 2-acrylamido-2 methylpropane sulphonic acid such as Acumer 3100 supplied by Dow. As an alternative, polymers and co-polymers of acrylic acid having a molecular weight between 500 and 20,000 can also be used, such as homo-polymeric polycarboxylic acid compounds with acrylic acid as the monomeric unit. The average weight of such homo-polymers in the acid form preferably ranges from 1,000 to 100,000 particularly from 3,000 to 10,000 e.g. Sokolan™ PA 25 from BASF or Acusol™ 425 from Dow.

Also suitable are polycarboxylates co-polymers derived from monomers of acrylic acid and maleic acid, such as CP 5 from BASF. The average molecular weight of these polymers in the acid form preferably ranges from 4,000 to 70,000. Modified polycarboxylates like Sokalan™CP42, Sokalan™ CP50 from BASF or Alcoguard™ 4160 from AkzoNobel may also be used.

Mixture of anti-scaling agents may also be used. Particularly useful is a mixture of organic phosphonates and polymers of acrylic acid.

It is preferable if the level of dispersing polymers ranges from 0.2 to 10 wt. % of the total composition, preferably from 0.5 to 8 wt. %, and further preferred from 1 to 6 wt. %.

### Other Ingredients

Glass corrosion inhibitors can prevent the irreversible corrosion and iridescence of glass surfaces in machine dishwash detergents. The claimed composition may suitably contain glass corrosion inhibitors. Suitable glass corrosion agents can be selected from the group the group consisting of salts of zinc, bismuth, aluminum, tin, magnesium, calcium, strontium, titanium, zirconium, manganese, lanthanum, mixtures thereof and precursors thereof. Most preferred are salts of bismuth, magnesium or zinc or combinations thereof. Preferred levels of glass corrosion inhibitors in the present composition are 0.01-2 wt. %, more preferably 10.01-0.5 wt. %.

Anti-tarnishing agents may prevent or reduce the tarnishing, corrosion or oxidation of metals such as silver, copper, aluminium and stainless steel. Anti-tarnishing agents such as benzotriazole or bis-benzotriazole and substituted or substituted derivatives thereof and those described in EP 723 577 (Unilever) may also be included in the composition. Other anti-tarnishing agents that may be included in the detergent composition are mentioned in WO 94/26860 and WO 94/26859. Suitable redox active agents are for example complexes chosen from the group of cerium, cobalt, hafnium, gallium, manganese, titanium, vanadium, zinc or zirconium, in which the metal are in the oxidation state of II, II, IV V or VI.

The present composition may suitably contain a non-surfactant, water-soluble, liquid binder, e.g. in a concentration of 0-50% by weight of the composition. Examples of such liquid binders include polyethylene glycols, polypropylene glycols, glycerol, glycerol carbonate, ethylene glycol, propylene gylcol and propylene carbonate.

The present composition preferably contains a viscosifier. By increasing the viscosity of the composition through the addition of a viscosifier a stable suspension of particles can be produced. Preferably, the composition contains 0.5-10 wt. % of a viscosifier.

Optionally other components may be added to the formulation such as perfume, colorant or preservatives.

The desired viscosity profile of the detergent composition depends on the end use of the product. It may be a liquid, gel or a paste depending on the application.

Another aspect of the present invention relates to a water-soluble sachet that is filled with a composition as defined herein before.

The inventors have found that the detergent composition of the present invention, despite the fact that it contains a substantial amount of water, can be packaged in a water-soluble sachet.

According to a preferred embodiment, the sachet comprises 5-40 ml, more preferably 10-30 ml and most preferably 15-25 ml of the detergent composition.

The water-soluble sachet is advantageously made of a polymer selected from polyvinyl alcohol,

cellulose ethers, polyethylene oxide, starch, polyvinylpyrrolidone, polyacrylamide, polyvinyl methyl ether-maleic anhydride, polymaleic anhydride, styrene maleic anhydride, hydroxyethylcellulose, methylcellulose, polyethylene glycols, carboxymethylcelulose, polyacrylic acid salts, alginates, acrylamide copolymers, guar gum, casein, ethylene-maleic anhydride resin series, polyethylene imine, ethyl hydroxyethylcellulose, ethyl methylcellulose, hydroxyethyl methylcellulose and combinations thereof. Preferably, the water-soluble sachet is made of polyvinyl alcohol, polyethelene oxide, polyvinylpyrrolidone and combinations thereof.

Most preferably, the water-soluble sachet is made of polyvinyl alcohol, a copolymer of polyvinyl alcohol and combinations thereof. Polyvinyl alcohols preferred have a weight average molecular weight between 1,000 and 300,000, more preferably, between 2,000 and 150,000, and most preferably, between 3,000 and 100,000.

Yet another aspect of the invention relates to a process of preparing a composition according to the present invention, said process comprising combining 100 parts by weight of a liquid mixture of GLDA and water with 10-300 parts by weight, preferably 20-100 parts by weight of GLDA powder to produce a liquid detergent base, said liquid mixture containing 20-50 wt. % of GLDA and 50-80 wt. % water and said GLDA powder containing at least 65 wt. % GLDA; and combining the liquid detergent base with an enzyme preparation containing active enzyme.

The enzyme preparation employed in the present process can be a liquid, a solid or a paste. Powders and granulates are examples of solid enzyme preparations that may be employed in the present process.

The inventors have unexpectedly discovered that liquid enzyme preparations that usually are more sensitive to alkaline conditions than solid enzyme preparations can suitably be employed in the present process as the resulting composition shows little reduction of enzyme activity during storage. Accordingly, in a particularly preferred embodiment of the present process, the enzyme preparation is a liquid enzyme preparation, notably a liquid enzyme preparation that contains at least 10 wt. %, more preferably at least 20 wt. % of water.

Preferably, the liquid detergent base that is obtained in the present method comprises GLDA and water in a weight ratio of GLDA to water that lies within the range of 9:10 to 3:1; more preferably of 1:1 to 5:2; and most preferably of 5:4 to 5:3

The liquid detergent base that is obtained in the present process preferably contains 50-70 wt. %, more preferably 53-68 wt. and most preferably 55-65 wt. % GLDA. The water content of the liquid detergent base preferably is in the range of 30-50 wt. %, more preferably 32-47 wt. % and most preferably 35-45 wt. %.

The liquid mixture of GLDA and water that is employed in the present process typically contains 30-50 wt. % of GLDA and 50-70 wt. % water. The GLDA powder preferably contains at least 70 wt. % of GLDA.

Together, GLDA and water typically represent at least 90 wt. %, more preferably at least 95 wt. % and most preferably at least 98 wt. % of the liquid mixture. Likewise, GLDA and water together also represent preferably at least 90 wt. %, more preferably at least 95 wt. % and most preferably at least 98 wt. % of the GLDA powder.

Preferably the liquid mixture of GLDA and water has a temperature of at least 5° C., more preferably of 10-80° C. and most preferably of 15-70° C. when it is combined with the GLDA powder in order to ensure that a fully liquid detergent base can be obtained without difficulty.

Advantageously, an acid component as defined herein before is present in the liquid detergent base, most preferably said acid component is added in protonated, i.e. acid form. Typically, the acid component is added in an amount of 0.1-10%, more preferably of 1-7% and most preferably 3-5% by weight of the total amount of GLDA in the liquid detergent base. The acid component may suitably be added to the composition before addition of the active enzyme.

Advantageously, before the addition of active enzyme, a viscosifier as defined herein before is incorporated in the liquid detergent base, typically in an amount of 0.5-10% by weight of the liquid base.

The invention is further illustrated by the following non-limiting examples.

### EXAMPLES

### Example 1

A liquid premix was prepared on the basis of the formulation presented in table 1.

TABLE 1

| Component | Weight % |
|---|---|
| GLDA (Dissolvine ™ GL PD-S)¹ | 31.61 |
| (80%) | |
| GLDA (Dissolvine ™ GL 47-S)² | 62.06 |
| (47%) | |
| Citric acid (50%) | 3.66 |
| Silica Sorbosil TC-15 | 2.67 |

¹Dissolvine ™ GL PD-S, solid powder of GLDA tetrasodium salt ex Akzo Nobel.
²Dissolvine ™ GL 47-S, a 47 wt % solution of GLDA tetrasodium salt ex Akzo Nobel.

The liquid premix base was prepared by adding a citric acid solution (50%) to Dissolvine™ GL 47-S at ambient temperature. After 10 minutes stirring the silica was added and the formulation was mixed under high shear for 15 minutes. Subsequently the Dissolvine™ GL PD-S was added and the sample was stirred for another 15 minutes.

To the premix so prepared different enzyme preparations were added in the amounts indicated in table 2.

TABLE 2

| | Enzyme | | | Concentration |
|---|---|---|---|---|
| Sample | type | Form | Product name | (g/100 g) |
| 1A | Protease | Liquid | Savinase Ultra | 1.5 |
| | | | 16L | |
| 1B | | Granulate | Savinase | 1 |
| | | | 24GTT | |
| 2A | Protease | Liquid | Exzellenz P100 | 2.7 |
| 2B | | Granulate | Excellase | 1 |
| | | | 2250D | |
| 3A | Amylase | Liquid | Stainzyme 12 L | 1 |
| 3B | | Granulate | Stainzyme 12 | 1 |
| | | | GT | |

The detergent compositions so prepared were stored at 37° C. in sealed containers. The enzyme activity of the compositions was measured immediately after preparation of the composition and after 1 and 2 weeks storage.

The residual enzyme activity (expressed as %) is the enzyme activity after storage (at 37° C.) of the detergent composition concerned divided by the enzyme activity of the freshly prepared composition.

Activity of amylase and protease was measured using standard enzyme analytical methods that have been published by Novozymes.

The amylase activity method is based on the amylolytic action of a-amylases on 4,6-ethylidene-p-nitrophenyl-a,Dmaltoheptaoside (ethylidene-G7PNP). The ethylidene-G7PNP reacts with the a-amylase to give G2PNP+G3PNP+G4PNP. The G2PNP+G3PNP+G4PNP react with a-glucosidase to glucose and the yellow p-nitrophenol (PNP). The reaction is followed in situ and the change in absorbance at 405 nm per time unit is calculated. The amylolytic activity is automatically calculated by referring to a calibration curve of the corresponding reference standard.

The protease activity method is based on the proteolytic action of proteases on dimethyl casein. The formed —NH2 groups react with the 2,4,6-trinitrobenzene sulphonic acid (TNBSA) yielding a yellow coloured complex. The reaction is followed in situ and the change in absorbance at 405 nm per time unit is calculated. The proteolytic activity is automatically calculated referring to a calibration curve of the corresponding reference standard.

The results of the stability test are shown in Table 3.

TABLE 3

Residual enzyme activity

| Sample | After 1 week | After 2 weeks |
|---|---|---|
| 1A | 89% | 88% |
| 1B | 100% | 87% |
| 2A | 88% | 86% |
| 2B | 89% | 87% |
| 3A | 90% | 84% |
| 3B | 100% | 100% |

### Comparative Example

Using the procedure described in Example 1 a liquid premix was prepared on the basis of the formulation presented in table 4 (recited percentages are wt. %).

TABLE 4

| | | GLDA | Water |
|---|---|---|---|
| Dissolvine ™ GL 47-S¹⁾ | 82% | 39% | 37% |
| (47%) | | | |
| Citric acid (50%) | 2.4% | | 1.2% |
| Water | 13% | | 13% |
| Silica Sorbosil TC 15 | 2.6% | | |
| Total | 100% | 39% | 51% |

To the premix so prepared different enzyme preparations were added in the amounts indicated in table 5.

TABLE 5

| | Enzyme | | | Concentration |
|---|---|---|---|---|
| Sample | type | Form | Product name | (g/100 g) |
| 1 | Protease | Liquid | Exzellenz P100 | 2.7 |
| 2 | Amylase | Liquid | Stainzyme 12 L | 1 |
| 3 | Amylase | Granulate | Stainzyme 12 | 1 |
| | | | GT | |

The detergent compositions so prepared were stored at 37° C. in sealed containers. The enzyme activity of the compositions was measured immediately after preparation of the composition and after 1 and 2 weeks storage, using the method described in Example 1. The results of this stability test are shown in Table 6.

TABLE 6

Residual enzyme activity

| Sample | After 1 week | After 2 weeks |
|---|---|---|
| 1 | 81% | 69% |
| 2 | 83% | 71% |
| 3 | 80% | 67% |

1. A composition containing at least 10 wt. % of GLDA (glutamic-N,N-diacetic acid and salts thereof), at least 10 wt. % water and one or more active enzymes; wherein the weight ratio of GLDA to water lies within the range of 5:6 to 5:1, preferably of 9:10 to 3:1; more preferably of 1:1 to 5:2; and wherein the composition contains less than 0.3% of bleach particles by weight of the composition, said bleach particles having a particle size of at least 10 μm.

2. Composition according to claim 1, the composition contains less than 0.3% of bleach particles by weight of the composition.

3. Composition according to claim 1, wherein the composition, when added to demineralised water having a temperature of 20° C. in a concentration of 1 g per 100 ml of water, yields an aqueous solution having a pH of at least 8, preferably of at least 9.

4. Composition according to claim 1, wherein the composition contains 0.1-10 wt. % of dissolved acid.

5. Composition according to claim 4, wherein the dissolved acid is selected from sulphuric acid, citric acid and combinations thereof.

6. Composition according to claim 1, wherein the composition has a water activity of not more than 0.7, preferably of not more than 0.6.

7. Composition according to claim 1, wherein the composition is a liquid, a gel or a paste.

8. Composition according to claim 1, wherein GLDA and water together constitute at least 35 wt. %, more preferably at least 40 wt. % of the composition.

9. Composition according to claim 1, wherein the one or more active enzymes are selected from protease, amylase, cellulase, peroxidase, mannanase, pectate lyase and lipase.

10. Composition according to claim 1, wherein the composition comprises at least 10 mg/kg of active enzyme.

11. Composition according to claim 10, wherein the composition contains at least 10 mg/kg of active amylase.

12. Composition according to claim 10, wherein the composition contains at least 100 mg/kg of active protease.

13. A water-soluble sachet filled with a composition according to claim 1.

14. A process of preparing a composition according to claim 1, said process comprising:
combining 100 parts by weight of a liquid mixture of GLDA and water with 10-300 parts by weight of GLDA powder to produce a liquid detergent base, said liquid mixture containing 20-50 wt. % of GLDA and 50-80 wt. % water and said GLDA powder containing at least 65 wt. % GLDA; and
combining the liquid detergent base with an enzyme preparation containing active enzyme.

15. Process according to claim 14, wherein the enzyme preparation is a liquid enzyme preparation.
